(19) United States
(12) Patent Application Publication
(10) Pub. No.: US 2013/0174935 A1
(43) Pub. Date: Jul. 11, 2013

(54) VARIABLE THIN WALLED DUCT WITH BEND

(71) Applicants: Curtis R. Patterson, II, Jupiter, FL (US); Mark J. Ricciardo, Jupiter, FL (US)

(72) Inventors: Curtis R. Patterson, II, Jupiter, FL (US); Mark J. Ricciardo, Jupiter, FL (US)

(21) Appl. No.: 13/347,107

(22) Filed: Jan. 10, 2012

(51) Int. Cl. F16L 9/00; B23K 28/00; B21D 7/00

(52) U.S. Cl. 138/177; 72/369; 29/428

(57) ABSTRACT

A method of manufacturing a duct is disclosed that is suitable for aerospace applications, for example. The method includes the steps of providing a longitudinally extending duct having a first wall thickness at an end portion and a second wall thickness at a portion that is less than the first wall thickness. The duct is bent at the portion to a desired shape to provide a tube having at least one bend located within a distance of one duct diameter from the first wall thickness.

This invention was made with government support from the National Aeronautics and Space Administration under Contract No.: NNM06AB13C. The government may have certain rights to this invention pursuant to Contract No. NNM06AB13C awarded by the National Aeronautics and Space Administration.

### BACKGROUND

This disclosure relates to a method of manufacturing a thin walled duct with a bend. This disclosure also relates to an engine having one or more thin walled ducts with bends.

Thin walled ducts or tubes are used in a wide variety of applications. Typically, a duct having a uniform wall thickness is bent to the desired shape. The wall thickness of the duct is selected based upon the most highly stressed area of the duct. Such an approach to duct design results in ducts having a thicker than necessary wall thickness along much of the length of the duct.

In aerospace applications, for example, ducts are used frequently. Precise alignment is required between the ends of the ducts and the adjoining components to which the ends are attached. Thus, flow lined pressure compensating bellows, which are heavy and costly, are often used to join the duct ends to their adjoining components. The use of compensating bellows may be avoided by increasing the wall thickness of the duct, along its entire length, which enables the ends to be welded to attaching flanges that then can be secured to the adjoining components, however, this approach increases the overall stiffness of the duct. Most aerospace architecture applications are, in part, centered around compactness which yield benefits in the form of reduced vehicle weight and improved aerodynamics. More compact duct arrangements help reduce vehicle engine envelope and thereby reduce overall vehicle gross weight. Variable wall thickness ducts increase ability to compact engine systems within smaller envelopes.

Chemical milling has been used to thin the wall thickness of bent ducts in aerospace applications. Typically, a uniform thickness duct is bent to the desired shape. The duct is masked around the desirably thick areas, and then chemicals are applied to the unmasked areas to chemically remove some of the wall thickness.

### BRIEF DESCRIPTION OF THE DRAWINGS

The disclosure can be further understood by reference to the following detailed description when considered in connection with the accompanying drawings wherein:

FIG. 1A is a schematic of an example duct prior to manufacturing according to the disclosed method.

FIG. 1B is a schematic of an example mechanical working process used to further manufacture the duct shown in FIG. 1A.

FIG. 1C is a schematic of the duct with a spacer in an uncompressed state prior to bending.

FIG. 1D is a schematic of the duct with the spacer in a compressed state prior to bending.

FIG. 1E is a schematic of an example bending process used to further manufacture the duct shown in FIG. 1B.

FIG. 1F is a schematic of the duct illustrated in FIG. 1E joined to a flange.

FIG. 2 is an example rocket engine incorporating ducts manufactured according to the disclosed method.

### DETAILED DESCRIPTION

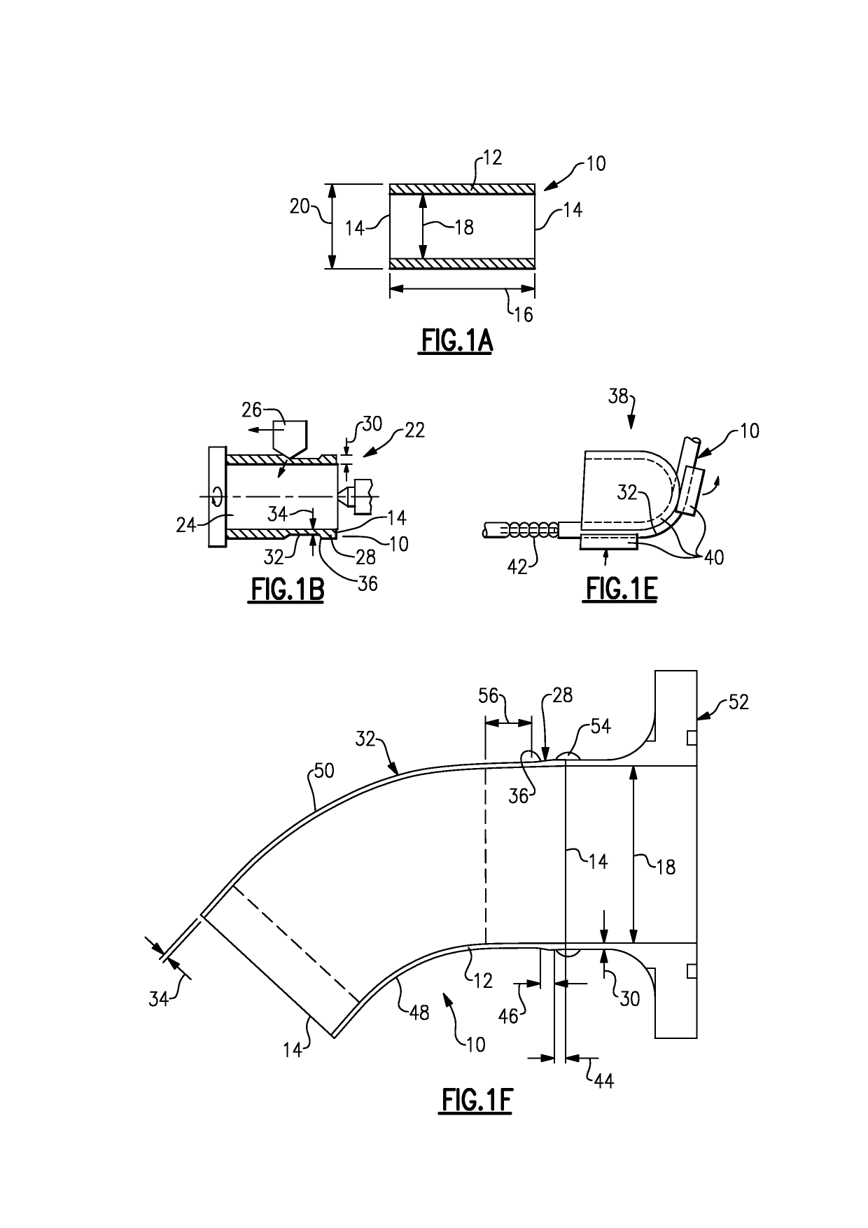

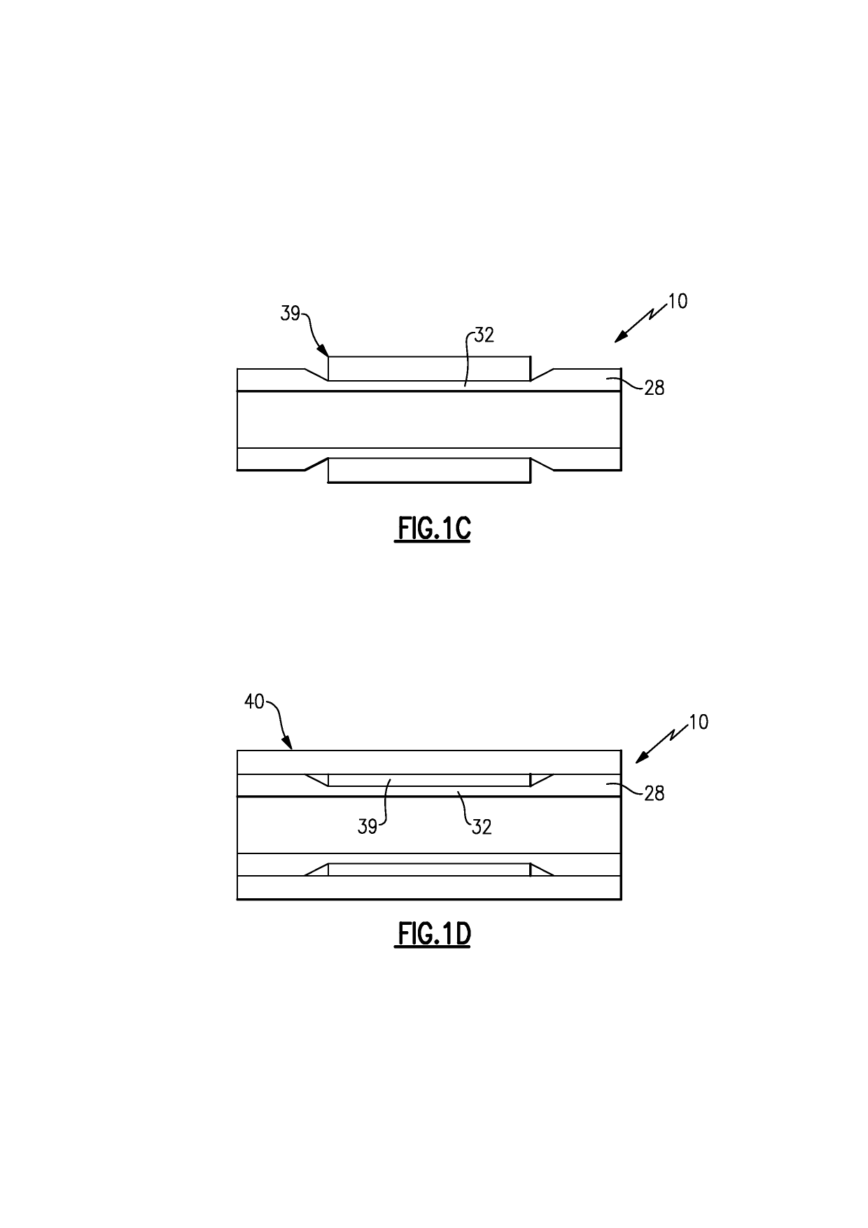

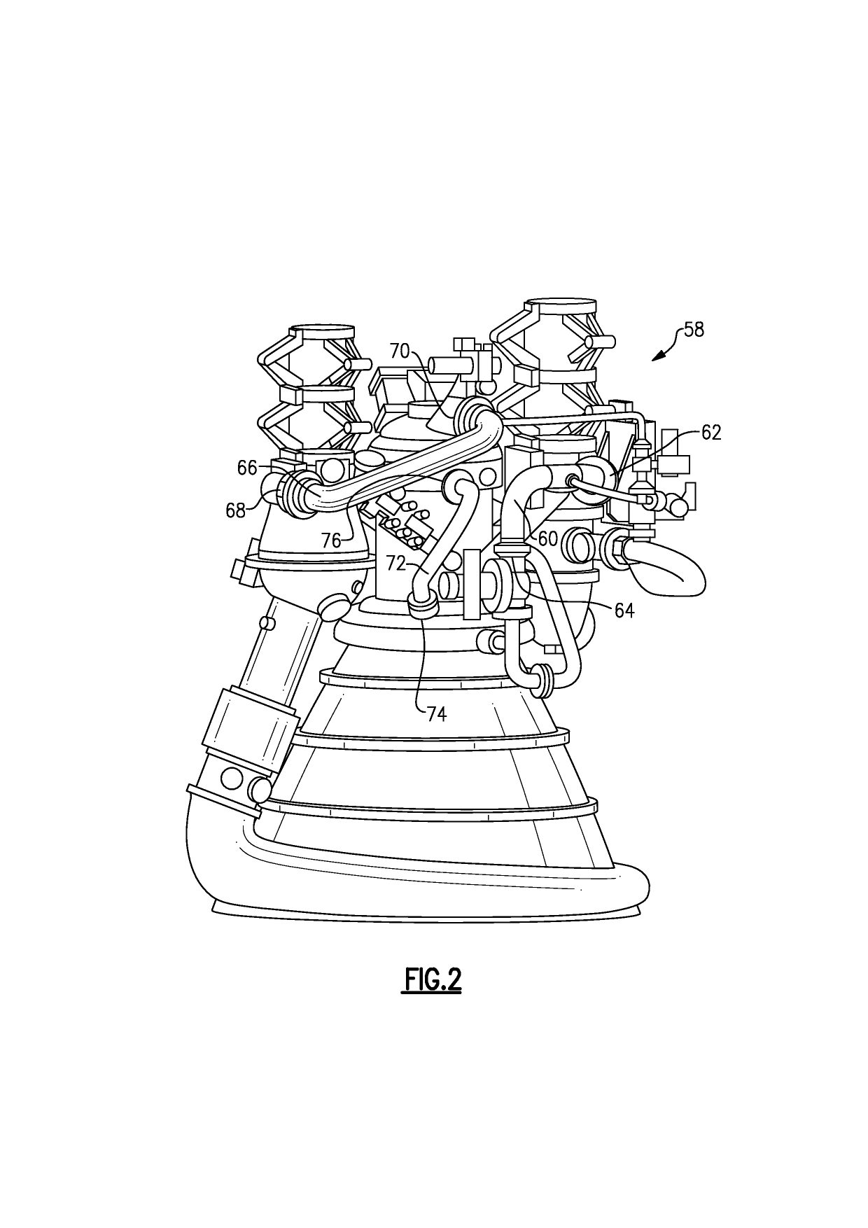

Referring to FIGS. 1A-1D, a manufacturing method is illustrated in which a duct having a variable wall thickness is formed from a straight preform having a uniform wall thickness.

A duct 10 is shown in FIG. 1A that includes a wall 12 having a generally uniform thickness defined by an inner diameter 18 and an outer diameter 20. The duct 10 may be constructed from nickel, titanium, aluminum, steel or alloys thereof, for example. The duct 10 extends linearly between ends 14 along a length 16. In one example, the duct 10 is provided by a seamless tube formed, for example, by flow forming, although other processes may be used to provide the tubular blank. The duct 10 may be formed by forging, for example. In one example, a cup-shaped structure may be forged having a cylindrical wall thickness of about a half an inch (12.7 mm) and an end wall of about of about a quarter inch (6.4 mm).

The duct 10 is mechanically worked, as illustrated in FIG. 1B. In one example, a machine 22 includes a mandrel 24 that supports the duct 10. A tool 26 engages an exterior surface of the duct 10, working from the end 14, to provide a first wall thickness 30 at an end portion 30 at the end 14. As the tool 26 moves along the exterior surface, material is displaced along a portion 32 of the duct 10 to provide a second wall thickness 34 that is less than the first wall thickness 30. In one example, the duct 10 has a “thin” wall with an initial outer diameter to wall thickness ratio of, for example, 40. Unlike a chemical milling process, the displaced exterior is not structurally impacted by the chemicals causing, for example, intergranular attack. In one example, the second wall thickness 34 is about half that of the first wall thickness 30. Although the end portions 28 are illustrated as the circumferential areas having the thicker wall thickness, it should be understood that other circumferential areas of the duct 10 may have thicker walls to provide localized strengthening.

Example mechanical working processes include flow forming, turning and grinding in which material is plastically deformed and/or removed from the exterior surface of the duct 10. Flow forming produces a smooth, wavy surface, which may in some cases have subtle surface ripples or waves. It also should be understood that the interior surface may be deformed to provide the variable wall thickness described above.

In the example, the end portions 28 are generally uniformly cylindrical. However, it should be understood than the end portions 28 may become ovalized from the bending operation, but if this occurs the ends will typically undergo a rounding operation. A transition 36 adjoins the end portion 28 and the portion 32 such that an abrupt step is avoided, which may be a byproduct of a given mechanical working process. Transition 36 is structurally beneficial as it mitigates the occurrence of undesirable stress concentrations from developing in the duct during engine operation.

A bending process is employed to produce a bend in the area of the portion 32. A spacer 39 is provided about the portion 32 prior to bending the duct 10 to the desired shape, as shown in FIG. 1C. In the example, the spacer 39 provides a diameter that is larger than the diameter of the end 28 in an uncompressed state. In one example, the spacer 39 is constructed from a soft, conformable PTFE sheet of material, such as GORE-TEX, wrapped about the portion 32. In an example shown in FIG. 1E, a bending machine 38 includes the fixtures 40, which are used to clamp and bend the duct 10. A mandrel 42, such as a ball mandrel, is arranged inside the duct 10 to maintain the inner diameter 18 (shown in FIG. 1A) during bending. The spacer 39 maintains the outer diameter of the portion 32, and is removed and discarded when then bending operation has been complete. The bends may be performed iteratively to avoid wrinkles, if needed. Although only one bend is shown, the duct 10 may include more than one bend.

Referring to FIG. 1D, the spacer 39 is sized such that when compressed by fixtures 40 during bending the spacer 39 fills and supports the portion 32 in its compressed state. Referring to FIG. 1F, the variable wall sections of the duct may be closed-coupled to the tangency point (indicated by the dashed lines) of the duct bend radius (extending between the intrados 48 and extrados 50), as indicated by distance 56. The distance 56 is defined as the distance from the tangency point to the location where the second wall thickness 34 transitions to the first wall thickness 30. In one example, the distance 56 is within one duct outer diameter or less, although it should be understood that this disclosure is also intended to include distances 56 of greater than one duct outer diameter. The ends portions 28 may be trimmed or squared up after the bending process to prepare for further processing. In one example, the tube is made with several inches of straight after the bend. The tube is subsequently trimmed leaving, for example, a minimum of four times the first wall thickness 30.

The thicker first wall thickness 30 provides strength in desired circumferential areas, while the thinner second wall thickness 34 provides a smaller cross section to reduce stiffness and/or eliminate unneeded weight. For example, the end portion 28 provides sufficient structure to accommodate the heat produced when securing to a flange 52 to the duct 10 by a weld bead 54. The end portion 28 has an end portion width 44 that is approximately four times the first wall thickness 30, for example, which sufficiently accommodates the heat when applying the weld bead 54. The transition 36 extends a transition width 46 that is three times the first wall thickness 30 in one example. The contour of the transition 36 is based upon the forming process and profile of the tool 26, for example.

The intrados (inner radius) 48 may be slightly thicker and the extrados (outer radius) 50 slightly thinner than the second wall thickness 34 from the bending process. The inner diameter 18 has a circular cross-section and is uniform in its dimensions and without wrinkles. It is desirable to provide the distance 56 adjoining the transition 36 and any bends for at least the reasons described above.

A rocket engine 58 is illustrated in FIG. 2 and includes several ducts 60, 66, 72 with flanges secured to the ducts' opposite ends similar to the arrangement shown in FIG. 1F. The ducts fluidly connect first and second components to one another.

A fuel turbopump discharge duct 60 fluidly connects a fuel turbopump 62 to a main fuel valve 64. An oxidizer turbopump discharge duct 66 fluidly connects an oxidizer turbopump 68 to a main oxidizer valve 70. A nozzle coolant discharge duct 72 fluidly connects a nozzle 74 to an injector mixer 76. The thinner portions of the duct are less stiff than the thicker portions to which the flanges are secured. This reduced stiffness desirably reduces the loads and stresses imparted to the components to which the ducts are secured.

Although an example embodiment has been disclosed, a worker of ordinary skill in this art would recognize that certain modifications would come within the scope of the claims. For that reason, the following claims should be studied to determine their true scope and content.

What is claimed is:

1. A method of manufacturing a duct comprising:
providing a longitudinally extending duct having a first wall thickness at an end portion and a second wall thickness at a portion that is less than the first wall thickness; and
bending the duct at the portion to a desired shape to provide a tube having at least one bend located within a distance of one duct diameter from the first wall thickness.

2. The method according to claim 1, comprising the step of, before the bending step, mechanically working an exterior surface of the duct to produce the first and second wall thicknesses.

3. The method according to claim 2, wherein the providing step includes a duct extending a length from the end to an opposite end, and the first wall thickness is generally uniform along the length.

4. The method according to claim 3, wherein the duct is provided by a seamless tube having an inner diameter to first wall thickness ratio of at least 40.

5. The method according to claim 2, wherein the mechanical working step includes flow forming.

6. The method according to claim 5, wherein the flow forming includes supporting the duct on a linearly extending mandrel while rolling the exterior surface.

7. The method according to claim 1, wherein the second wall thickness is about half of the first wall thickness.

8. The method according to claim 7, wherein the bend includes an outer radius having bend thickness of less than the second wall thickness, and an inner radius of greater than the second wall thickness.

9. The method according to claim 2, wherein the mechanically working step provides an end portion at the end having the first wall thickness, and comprising the step of trimming the end portion to a width of about at least four times the first wall thickness.

10. The method according to claim 9, comprising the step of welding a flange to the end portion.

11. The method according to claim 1, wherein the bending step includes mandrel tube bending, and the second wall thickness has an outer diameter supported by a conformable spacer during bending.

12. The method according to claim 2, wherein mechanical working step produces a smooth, wavy surface finish.

13. An aerospace system comprising:
first and second components; and
a tube having at least one bend fluidly connecting the first and second components, the tube extending a length between opposite ends and including a uniform inner diameter, an end portion at one end having a first wall thickness and another portion spaced from the end portion and including a circumference having a second wall thickness less than the first wall thickness.

14. The system according to claim 13, wherein the other portion has an exterior surface with a smooth, wavy surface.

15. The system according to claim 13, wherein the second wall thickness is about half of the first wall thickness, the end portion at each end extending an end portion width of about at least four times the first wall thickness, and a flange is welded to each of the end portions.
